(19) United States
(12) Patent Application Publication
(10) Pub. No.: US 2006/0032836 A1
(43) Pub. Date: Feb. 16, 2006

(54) METHODS OF CONTROLLING THE PROPERTIES OF ABRASIVE PARTICLES FOR USE IN CHEMICAL-MECHANICAL POLISHING SLURRIES

(75) Inventors: Xiangdong Feng, Upland, CA (US); Yie-Shein Her, Canandaigua, NY (US)

Correspondence Address: RANKIN, HILL, PORTER & CLARK, LLP, 925 EUCLID AVENUE, SUITE 700, CLEVELAND, OH, 44115-1405, US

(73) Assignee: FERRO CORPORATION, Cleveland, OH (US)

(21) Appl. No.: 11/162,337

(22) Filed: Sep. 7, 2005

Related U.S. Application Data
(63) Continuation-in-part of application No. 10/851,684, filed on May 21, 2004.
Application No. 10/851,684 is a continuation-in-part of application No. 10/255,136, filed on Sep. 25, 2002, now Pat. No. 6,818,030.
Application No. 10/255,136 is a continuation-in-part of application No. 09/992,485, filed on Nov. 16, 2001, now Pat. No. 6,596,042.

(51) Int. Cl. C03C 15/00; B44C 1/22

(52) U.S. Cl. 216/88; 216/89

(57) ABSTRACT

The present invention provides methods of controlling the properties of abrasive particles produced via hydrothermal synthesis for use in chemical-mechanical polishing slurries. In accordance with the methods of the invention, variables such as cerium salt concentration, dopant solution concentration, hydrothermal medium pH, hydrothermal temperature and processing duration are controlled to produce particles having the desired properties and shapes. The abrasive particles formed in accordance with the method of the invention can be used to produce CMP slurries that provide substantial improvements in the polishing of STI structures and a reduction in defects.

### CROSS-REFERENCE TO RELATED APPLICATIONS

This application is a continuation-in-part of co-pending U.S. application Ser. No. 10/851,684, filed May 21, 2004, which is a continuation-in-part of U.S. application Ser. No. 10/255,136, now U.S. Pat. No. 6,818,030, filed Sep. 25, 2002, which is a continuation-in-part of U.S. application Ser. No. 09/992,485, now U.S. Pat. No. 6,596,042, filed Nov. 16, 2001.

### BACKGROUND OF THE INVENTION

1. Field of Invention

The present invention relates to methods of controlling the properties of abrasive particles for use in chemical-mechanical polishing slurries.

2. Description of Related Art

Chemical-mechanical polishing (CMP) slurries are used, for example, to planarize surfaces during the fabrication of semiconductor chips and the like. CMP slurries typically include reactive chemical agents and abrasive particles dispersed in a liquid carrier. The abrasive particles perform a grinding function when pressed against the surface being polished using a polishing pad.

It is well known that the size, composition, and morphology of the abrasive particles used in a CMP slurry can have a profound effect on the polishing rate. Over the years, CMP slurries have been formulated using abrasive particles formed of, for example, alumina (Al₂O₃), ceric oxide (CeO₂), iron oxide (Fe₂O₃), silica (SiO₂), silicon carbide (SiC), silicon nitride (Si₃N₄), tin oxide (SnO₂), titania (TiO₂), titanium carbide (TiC), tungstic oxide (WO₃), yttria (Y₂O₃), zirconia (ZrO₂), and combinations thereof. Of these oxides, ceric oxide (CeO₂) is the most efficient abrasive in CMP slurries for planarizing silicon dioxide insulating layers in semiconductors because of its high polishing activity.

Calcination is by far the most common method of producing abrasive particles for use in CMP slurries. During the calcination process, precursors such as carbonates, oxalates, nitrates, and sulphates, are converted into their corresponding oxides. After the calcination process is complete, the resulting oxides must be milled to obtain particle sizes and distributions that are sufficiently small to prevent scratching.

The calcination process, although widely used, does present certain disadvantages. For example, it tends to be energy intensive and thus relatively expensive. Toxic and/or corrosive gaseous byproducts can be produced during calcination. In addition, it is very difficult to avoid the introduction of contaminants during the calcination and subsequent milling processes. Finally, it is difficult to obtain a narrow distribution of appropriately sized abrasive particles.

It is well known that CMP slurries containing contaminants and/or over-sized abrasive particles can result in undesirable surface scratching during polishing. While this is less critical for coarse polishing processes, in the production of critical optical surfaces, semiconductor wafers, and integrated circuits, defect-free surfaces are required. This is achievable only when the abrasive particles are kept below about 1.0 μm in diameter and the CMP slurry is free of contaminants. The production of abrasive particles meeting these requirements by conventional calcination and milling techniques is extremely difficult and often not economically feasible.

An alternative method of forming abrasive particles for use in CMP slurries is hydrothermal synthesis, which is also known as hydrothermal treatment. In this process, basic aqueous solutions of metal salts are held at elevated temperatures and pressures for varying periods of time to produce small particles of solid oxide suspended in solution. A method of producing ceric oxide (CeO₂) particles via hydrothermal treatment is disclosed, for example, in Wang, U.S. Pat. No. 5,389,352.

The production of abrasive particles by hydrothermal treatment provides several advantages over the calcination/milling process. Unfortunately, however, abrasive particles formed by conventional hydrothermal treatment processes tended not to provide desired high polishing rates, at least when compared to abrasive particles having the same diameter (typically referred to in the art as “secondary particle size”) formed by calcination and milling.

In U.S. application Ser. No. 09/992,485, now U.S. Pat. No. 6,596,042, applicants disclosed an improved hydrothermal treatment process for producing abrasive particles suitable for use in CMP slurries. Applicants discovered that adding a crystallization promoter such as Ti[OCH(CH₃)₂]₄ (titanium (IV) isopropoxide) to an aqueous solution of a cerium salt such as (NH₄)₂Ce(NO₃)₆ (ammonium cerium (IV) nitrate) produced abrasive particles that had a larger crystallite size (typically referred to in the art as “primary particle size”) than abrasive particles formed by conventional hydrothermal treatment processes. Although the mechanism was not fully known by applicants at the time of filing that application, applicants speculated that the presence of the crystallization promoter accelerated the crystal growth of crystallites during hydrothermal treatment, which resulted in the production of abrasive particles that more aggressively polished silicon dioxide films than conventional abrasive particles formed by hydrothermal synthesis (see col. 3, lines 40-60).

In co-pending U.S. application Ser. No. 10/255136, which was published as U.S. patent application Pub. No. US2003/0093957A1, applicants disclosed that elemental analysis of abrasive particles formed via the hydrothermal treatment of an aqueous solution of a cerium salt and a titanium crystallization promoter showed that titanium atoms were present in the cubic crystal lattice structure, even though no titanium dioxide or anatase or rutile crystal phase was observable via X-ray diffraction crystallography. Applicants hypothesized that titanium atoms were incorporated into the cubic cerium crystal structure as replacements for cerium atoms (see paragraph [0022] of the specification of the published application).

Subsequent research by applicants has focused on controlling the properties of abrasive particles formed by hydrothermal treatment. Applicants have determined that the primary factors that influence the properties of abrasive particles for use in the removal of silicon dioxide films in the Shallow Trench Isolation (STI) process are: (1) the chemical reactivity of the abrasive particles; (2) the primary particle size of the abrasive particles; (3) the secondary particle size of the abrasive particles; and (4) the morphology of the abrasive particles (i.e., the shape of the particles and whether the particles are crystalline or amorphous).

### BRIEF SUMMARY OF THE INVENTION

The present invention provides methods of controlling the properties of abrasive particles produced via hydrothermal synthesis for use in chemical-mechanical polishing slurries. As used in the present specification and in the appended claims, the phrase “hydrothermal treatment” refers to the direct synthesis of inorganic particles from aqueous solutions at relatively low temperature (e.g., from about 100° C. to about 374° C., which are the boiling and critical points of water) and relatively moderate pressure (e.g., up to about 15 Mpa). The methods of the present invention allow for control over properties such as the primary and secondary particle size, the shape and the crystal phase of the abrasive particles produced by hydrothermal treatment. In accordance with the methods of the invention, variables such as cerium salt concentration, dopant solution concentration, hydrothermal medium pH, hydrothermal temperature and processing duration are controlled to produce particles having the desired properties. The abrasive particles formed in accordance with the method of the invention can be used to produce CMP slurries that provide substantial improvements in the polishing of STI structures and a reduction in defects.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a plot of resultant primary particle size and secondary particle size as a function of molar cation concentration.

FIG. 2a is a plot of primary particle size as a function of base excess for two valences of cerium.

FIG. 2b is a plot of secondary particle size as a function of base excess for two valences of cerium.

FIG. 3a is a plot of primary particle size as a function of ammonium hydroxide excess and cerium (IV) concentration.

FIG. 3b is a plot of secondary particle size as a function of ammonium hydroxide excess and cerium (IV) concentration.

FIG. 4a is a plot of primary particle size as a function of reaction temperature and duration.

FIG. 4b is a plot of secondary particle size as a function of reaction temperature and duration.

FIG. 5a is a transmission electron micrograph of an abrasive particle formed using an excess of potassium hydroxide.

FIG. 5b is a transmission electron micrograph of an abrasive particle formed using an excess of ammonium hydroxide.

FIG. 5c is a transmission electron micrograph of an abrasive particle formed using an excess of urea.

FIG. 6a is a composite showing the predicted unit cell structure (top) and close-up view of lattice constants (bottom) of a 12.5 mole percent titanium-doped ceria crystal.

FIG. 6b is a composite showing the predicted unit cell structure (top) and close-up view of lattice constants (bottom) of a 25 mole percent titanium-doped ceria crystal.

FIG. 7 is a graph showing oxide and nitride removal rate as a function of titanium mole percentage.

### DETAILED DESCRIPTION OF THE INVENTION

1. Abrasive Particle Preparation

To produce particles in accordance with the invention, a desired amount of a water-soluble metal salt such as ammonium cerium (IV) nitrate is dissolved in de-ionized water to form a first solution. A desired amount of a dopant metal compound (also sometimes referred to herein as a crystallization promoter) such as titanium (IV) isopropoxide, for example, is also dissolved in de-ionized water preferably together with a desired amount with a stabilizer such as acetyl acetone, which retards the hydrolysis of the dopant metal compound, to form a second solution. The first solution and the second solution are contacted together, preferably by adding the second solution into the first solution in a drop-wise manner. Once the first solution and the second solution are mixed together, a proper amount of a pH adjuster such as a base (e.g., ammonia hydroxide solution) is added to convert the mixture of the first solution and the second solution into gel-like mixture. The gel-like mixture is preferably stirred, sonicated and then heated in a reaction vessel at predetermined temperature and predetermined pressure for a predetermined period of time. After the hydrothermal treatment is concluded, the supernatant is decanted from the abrasive particle slurry thus formed. The abrasive particles are preferably washed and dried.

As noted above, the preferred metal salts are cerium salts, with (NH₄)₂Ce(NO₃)₆ (ammonium cerium (IV) nitrate) presently being most preferred. However, it will be appreciated that salts of metals other than cerium can be used. The valence of the cerium in the cerium salt is not per se critical. Suitable cerium compounds for use in the invention include, for example, cerium nitrate, cerium chloride, cerium sulfate, cerium bromide, and cerium iodide.

The mixture must also comprise one or more dopant metal compounds (“crystallization promoters”). The presently most preferred crystallization promoter is a titanium compound, namely Ti[OCH(CH₃)₂)]₄ (titanium (IV) isopropoxide), but other titanium compounds can be also used including, for example, titanium chloride, titanium sulfate, titanium bromide, and titanium oxychloride.

It is also possible to use compounds of metals other than titanium as dopant metal compounds. Salts of alkaline earth metals (group IIA of the periodic table), transition metals (element 21, scandium, through element 29, copper; element 39, yttrium, through element 47, silver; element 57, lanthanum, through element 79, gold; and element 89, actinium, and higher), aluminum, zinc, gallium, germanium, cadmium, indium, tin, antimony, mercury, thallium, lead and bismuth can be used.

Titanium (IV) isopropoxide is prone to rapid hydrolysis in the presence of water (it “smokes” in air). To prevent premature degradation of the titanium (IV) isopropoxide, it is preferable that the compound be treated with a stabilizer such as acetyl acetone, which can modify and thus protect the alkoxide via a ligand exchange reaction.

One or more bases can be optionally added to raise the pH of the mixture to greater than 7.0 and assist in the formation of a mixture having a gel-like consistency. Suitable bases include, for example, ammonium hydroxide, potassium hydroxide, organoamines such as ethyl amine and ethanol amine, and/or polyorganoamines such as polyethylene imine. The gel-like mixture formed upon adding a base will break down into small particles upon rapid stirring.

Other compounds such as urea, for example, can be used as precursors for a base. Urea does not act as a base until it is heated, so it does not tend to form a gel-like mixture when added, but rather will form a clear solution.

The mixture, whether in the form of a gel-like mixture or a clear solution, is then subjected to hydrothermal treatment. This is typically accomplished by heating the mixture in a sealed stainless steel vessel to a temperature of from about 60° C. to about 700° C. for a period of time of from about 10 minutes to many hours. At the completion of the reaction, the stainless steel vessel can be quenched in cold water, or it can be permitted to cool gradually over time. The mixture can be, but need not be, stirred during hydrothermal treatment. It is also possible to carry out the reaction in an autoclave unit with constant stirring.

2. Controlling the Size of Abrasive Particles

In a basic environment, cerium and titanium cations in their starting salts hydrolyze to form hydroxide or hydrous oxide nuclei, which convert to a composite oxide via a dissolution-reprecipitation mechanism of crystal growth during hydrothermal treatment. The change of synthesis conditions affects this nuclei formation and growth mechanism, and as a result, the final particle properties are changed.

A typical nano-sized abrasive particle (sometimes referred to herein simply as a “nanoparticle” or a “secondary particle”) generally consists of several primary particles that have agglomerated together due to their very high surface-to-volume ratio. The strength and size of the agglomerates (secondary particles) depends on the surface properties of the nanocrystalline particles, and these properties are sensitively dependent on the particle synthesis conditions. In accordance with the methods of the invention, primary particle and secondary particle sizes of abrasive particles can be independently controlled through changes in the starting cation concentrations, starting salt type, base amount, reaction duration and reaction temperature.

a. The Effect of Initial Cation Concentration on Secondary Particle Size

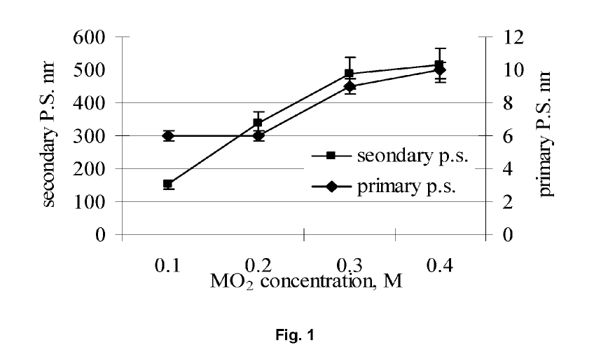

FIG. 1 is an exemplary plot of resultant primary particle size and secondary particle size in nanometers as a function of molar cation concentration, including both host and dopant metal cations. FIG. 1 shows that the initial concentration of the cation at the start of the reaction has a dominant effect on the secondary particle size of the resulting particles, and only a comparatively minor effect on the growth of the primary particle size (crystallite size). Primary particle size increases only slightly as a result of initial cation concentration. In concentrated solutions, the average diffusion distance for the diffusing solute is short and the concentration gradient is steep. Thus more and more diffusing material passes per unit time through a unit area, which favors more and more crystal growth of particles. When starting with highly concentrated solutions, a large number of particles are formed within the same liquid volume, the mean path of particle collisions is shortened and the high ionic strength also reduces the thickness of the particle double layers, all of which favor the agglomeration of particles. Thus, cation concentration appears to be an important factor in controlling secondary particle size growth, but it does not appear to be a very important factor in controlling primary particle size.

b. The Effect of Host Cation Valence on Primary Particle Size

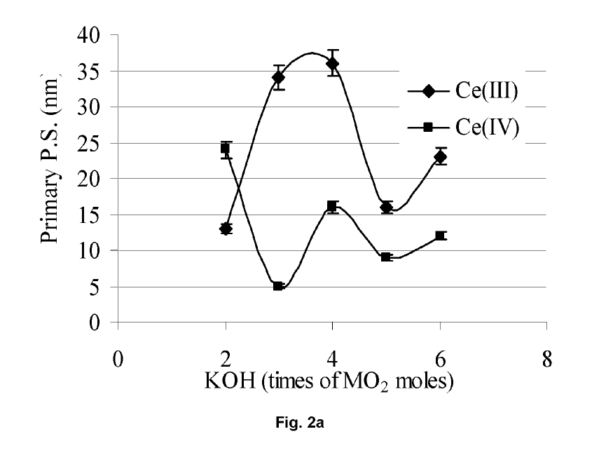

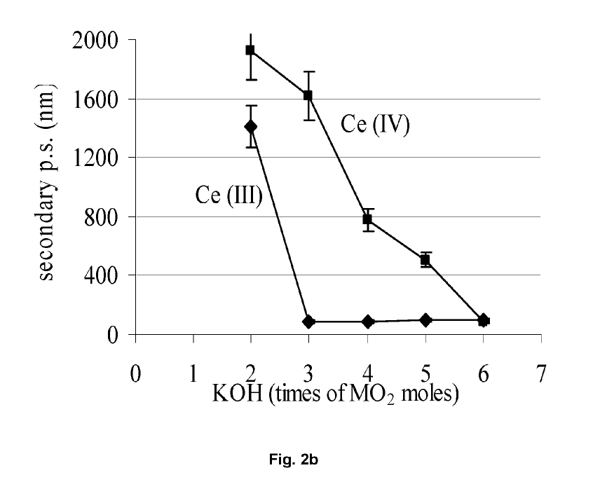

FIGS. 2a and 2b are exemplary plots of resultant primary particle size in nanometers and secondary particle size in nanometers, respectively, as a function of initial cation valence and basicity for titanium doped cerium particles. The most stable valence of lanthanide series elements is +3. Cerium is the only lanthanide series element having a +4 valence that is stable enough to exist in aqueous and solid compounds. The typical orange color of ceric salt is due to charge transfer interactions between Ce(IV) and Ce(III). The electrode potential of Ce(IV)/Ce(III)—(E[Ce(IV)/Ce(III)]=1.45+0.059([Ce⁴⁺]/[Ce³⁺]))—depends on the anion type in the solution, e.g. E₀=1.70v(1M HClO4), 1.61v(1M HNO₃), 1.44v(H₂SO₄), 1.28v (1M HCl) (Cotton & Wilkson, Adv. Inorg. Chem.).

FIG. 2a shows that primary particles from cerous (III) nitrate have coarser primary particle size than particles from ceric (IV) nitrate. Because the solubility of Ce(OH)₃ is six orders or magnitude greater than that of Ce(OH)₄, a Ce(OH)₃ solution is much less oversaturated than a Ce(OH)₄ solution when the same moles of cerous (III) nitrate and ceric (IV) nitrate are used at the same basicity. This means that there are fewer nucleation particles for Ce(OH)₃, and more chances for the particles that do nucleate to grow than compared to Ce(OH)₄. However, the valent effect for secondary particle size is opposite, probably because of the higher tendency for agglomeration of smaller primary particles from the ceric (IV) salt than from the cerous (III) salt. In the case of the cerous (III) salt, the growth of primary particles is so rapid that there are insufficient cerium ions in the solution to feed the crystal growth. Agglomerated smaller primary particles are therefore consumed in the growth of larger primary particles, resulting in the production of particles having a larger primary particle size and a smaller secondary particle size. Thus, the selection of initial cation valence can also be used to control primary and secondary particle size.

In addition to selecting the proper initial cation valence, it is also important to select an appropriate anion. In the production of cerium-containing abrasive particles, it is generally undesirable to use cerium sulfate as a substitute for cerium nitrate. Cerium nitrate tends to produce more crystalline particles than cerium sulfate. Furthermore, cerium sulfate tends to produce noxious chemicals (e.g., sulfide) as a byproduct during hydrothermal treatment. Thus, the proper selection of cerium starting salt, not only in cation valence, but also in anion group is very critical for the final particulate properties and for the safe particle production.

c. Effect of pH on Particle Size

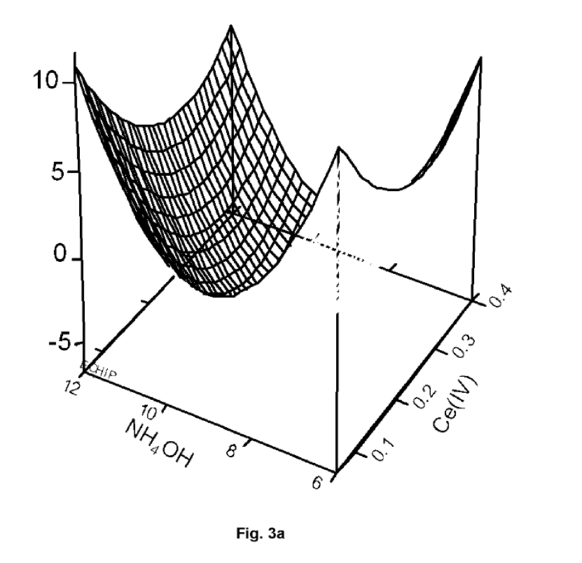

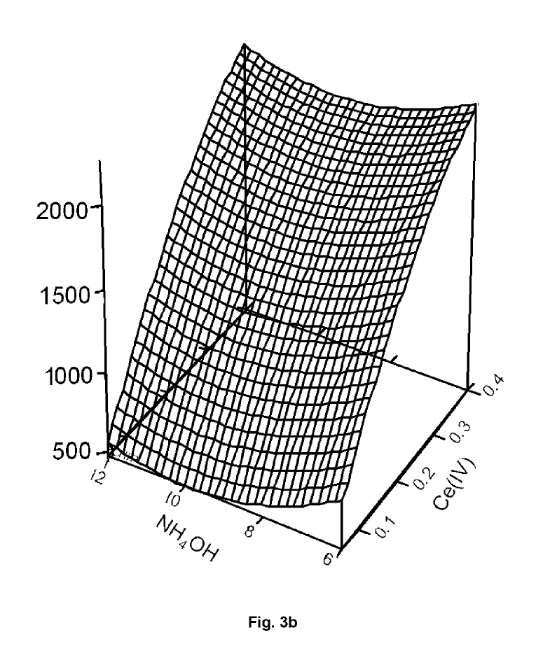

The pH of the medium from which particles are precipitated is known to have a significant effect on particle size growth for many oxides. To study this effect in the context of the hydrothermal precipitation of ceria particles, increasingly greater molar amounts of ammonia were used to precipitate ceria particles. FIGS. 3a and 3b are a plot of primary particle size and secondary particle size, respectively, of ceria particles precipitated as a function of molar ammonia concentration (i.e., moles of ammonia times the number of moles of cerium (IV) cations in solution) and initial cerium (IV) cation concentration. FIGS. 3a and 3b show the effects of excess amount of ammonia (6 to 12 times as many moles of ammonia per mole of cerium (IV) cations) on primary particle size and secondary particle.

The influence of reaction media pH on resultant particle size is complicated, and the explanation for the decrease and then increase in crystallite size upon the addition of excessive base is not clearly established. Applicants hypothesize that the initial increase in the amount of ammonia (from 6× to 10×) results in a higher concentration of hydroxides. This means that more nuclei are formed under higher pH conditions with the same starting cerium concentration. More nuclei compete for the same amount of cerium supply in the solution, resulting in the low concentration solute in the solution, and thus the rate of crystal growth may be low due to the insufficient supply of the solute by diffusion, resulting in a decrease in particle size. As more ammonia is added (from 10× to 12×), the additional amount of ammonia does not contribute to more hydroxide in the solution due to the limited basicity of ammonia. On the other hand, the large amount of ammonia may enhance the formation of cerium-ammonia complexes on the surface, which retards the dissolution of the primary crystals. If the primary crystal dissolution is hindered while the dissolution-reprecipitation equilibrium established for the growth of the primary crystals continues, the result may be an increase in primary particle size.

An increase in the amount of ammonia decreases secondary particle size, as shown in FIG. 3b. This is probably due to the fact that the insufficient supply of cerium in the solution as more ammonia is added also promotes the consumption of the agglomerated small primary crystals to sustain other primary crystallite growth (an effective de-agglomeration). The coating of cerium particles with ammonia through cerium-ammonia complex formation discussed previously also does not favor secondary particle size growth.

d. Effect of Temperature and Duration on Particle Size

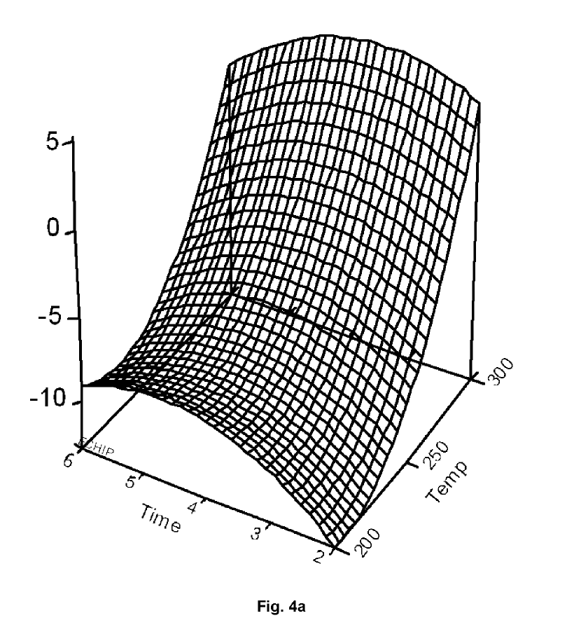

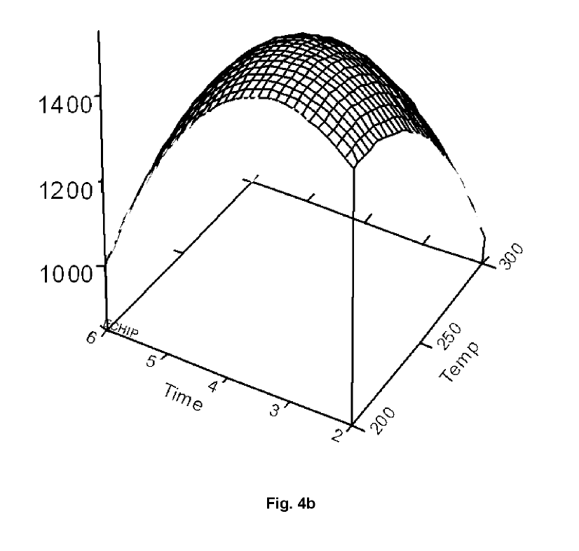

FIGS. 4a and 4b show a plot of primary particle size and secondary particle size, respectively, as a function of hydrothermal temperature and duration for titanium-doped cerium particles. As shown in FIG. 4a, primary particle size increases proportionately with an increase in hydrothermal treatment temperature (200° C. to 300° C.). This is believed to be due to the fact that high temperature provides a high driving force and energy for the growth of the crystals (hydrothermal conversion of cerium hydroxide to ceria is an endothermic process). FIG. 4b shows that the secondary particle size decreases proportionately with temperature. With the limited amount of cerium in the reaction system, the growth of some of the primary particles has to be at the expense of some other smaller primary crystals (smaller particles have higher solubility). This process effectively consumes part of the agglomerated primary particles, resulting in smaller secondary particle sizes.

The reaction duration effects on particle size (both primary and secondary) are much less pronounced in comparison with the temperature effects. Increases in reaction time increase the primary particle size due to the time needed to build the crystals and the fact that the large crystals built do not re-dissolve as long as the reaction conditions do not change. The temperature of reaction offers us yet another useful control in manipulating primary and secondary particle size.

3. Controlling the Shape of Abrasive Particles

Nanoparticles usually have definite, specific shape, especially when they are small, because single crystal nanoparticles have to be enclosed by crystallographic facets that have lower energy. Surface energies associated with different crystallographic planes are usually unique, for face centered cubic structures. Single-crystalline particles with high-index crystallography planes have a high surface energy whereas single-crystalline particles with low-index planes have lower surface energy.

In accordance with the methods of the present invention, it is possible to produce particles having a desired shape by selecting a shape-determining base such as, for example, urea, ammonia hydroxide and potassium hydroxide, for the hydrolysis of the metal cations. Among the three bases, with the same mole amount of base addition, urea has the lowest concentration of hydroxide ions and therefore can react with the fewest cerium nuclei before hydrothermal treatment. When heated at the proper temperature, urea dissociates to produce ammonium and cyanate ions (H₂N—CO—NH_{2NH}₄⁺+OCN⁻). When heated in neutral and basic conditions, the cyanate ions react to form carbonate ions and ammonia (OCN⁻+OH⁺+H₂O→NH₃+CO₃²⁻). Potassium hydroxide, on the other hand, provides the highest hydroxide concentration due to its complete dissociation of hydroxyl group. Ammonia produces less hydroxide ions than potassium hydroxide, but more than urea.

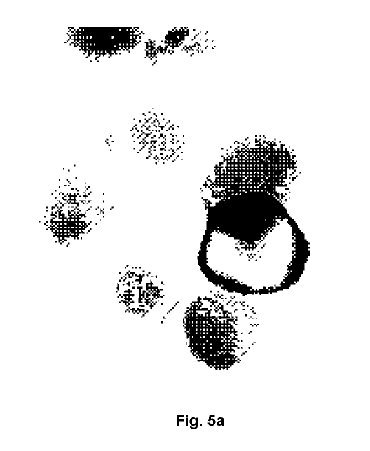

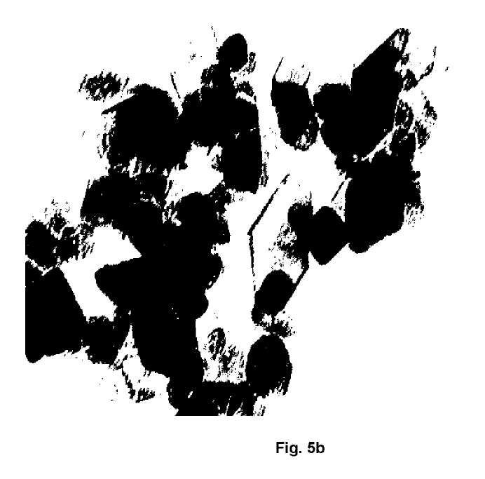

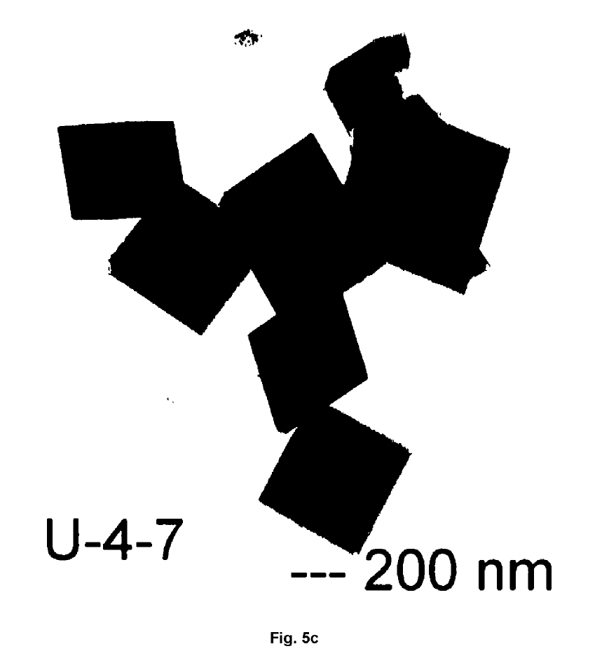

Cerium and titanium cations were subjected to hydrothermal treatment in the presence of potassium hydroxide, ammonium hydroxide and urea, resepctively, under the same conditions. Transmission electron microscope (TEM) micrographs of the particles formed using are potassium hydroxide, ammonium hydroxide and urea, respectively, are shown in FIGS. 5a, 5b and 5c, respectively. Urea produces abrasive particles having a polyhedral shape. Potassium hydroxide produces particles having a near spherical octahedral shape. And, ammonium hydroxide produces particles having a truncated octahedron shape.

Thus, the methods of the invention can be used to produce monodispersed titanium-doped cerium nanoparticles through hydrothermal conditions. The primary and secondary particle sizes of these particles can be controlled independently. Precise control is achieved through manipulating the concentrations of starting cerium ions and dopant titanium ions, the amount of base used, the reaction temperature, duration and the species of starting cerium salt. The particle shape can be controlled via the use of different shape-determining bases such as urea, ammonia, and potassium hydroxide, which preferentially promote low energy surface growth and the formation of high-energy facets.

4. Controlling Crystal Phase and Lattice Structure

a. Controlling Crystal Phase

The XRD spectra for pure ceria demonstrated the existence of a cubic phase, while the pure titania particle has a sharp peak of anatase phase. When the mole percentage of titanium cations in the crystal was less than or equal to 30%, only a ceria cubic phase could be identified. When the mole percentage of titanium cations in the crystal was between 40% and 80%, a separate titania anatase phase pronouncedly appeared, which was mixed with a ceria cubic phase. When the mole percentage of titanium cations exceeded 90%, the dominant crystal phase was anatase, and the particles could be considered as ceria-mixed or doped titania particles.

b. Controlling Lattice Structure

Table 1 below sets forth the lattice constants (in nanometers), the lattice strain (a percentage) and crystal size (in nanometers) of ceria particles formed in accordance with the method of the invention with 0, 6.25, 10, 12.5, 20 and 25 mole percent titanium cations:

TABLE 1

| Titanium | Lattice | Lattice | Crytal Size, |
|---|---|---|---|
| Mole % | constant, nm | strain, % | nm |
| 0 | 0.542 | 0 | 6 |
| 6.25 | 0.542 | N/A | N/A |
| 10 | 0.539 | 0.285 | 25 |
| 12.5 | 0.539 | N/A | N/A |
| 20 | 0.534 | 0.141 | 15 |
| 25 | 0.531 | N/A | N/A |

As a result of a mismatch of the ionic radius of Ce⁴⁺ (97 pm) and Ti⁴⁺ (68 pm), and a mismatch of cation valence due to the possible redox reaction of the Ce(IV)/(III) couple during synthesis, a resulting lattice strain and probable electrostatic interaction by a space charge mechanism, is expected. This lattice strain leads to the bonding imbalances in different directions of Ce atom and neighboring Ti atoms, resulting in an increase of structure surface energy. Active sites on the energy-enhanced surface attract new atoms (Ce⁴⁺ or Ti⁴⁺) to grow on it to relieve the strain and to lower the surface energy. As a result, with the Ti atom doping into the CeO₂ structure (eg. 10 mole % Ti doped ceria), the lattice strain increased when compared to the pure CeO₂ structure, leading to the enhancement of nuclei growth and crystal size with in situ dissolution and reprecipitation mechanism during the hydrothermal treatment process.

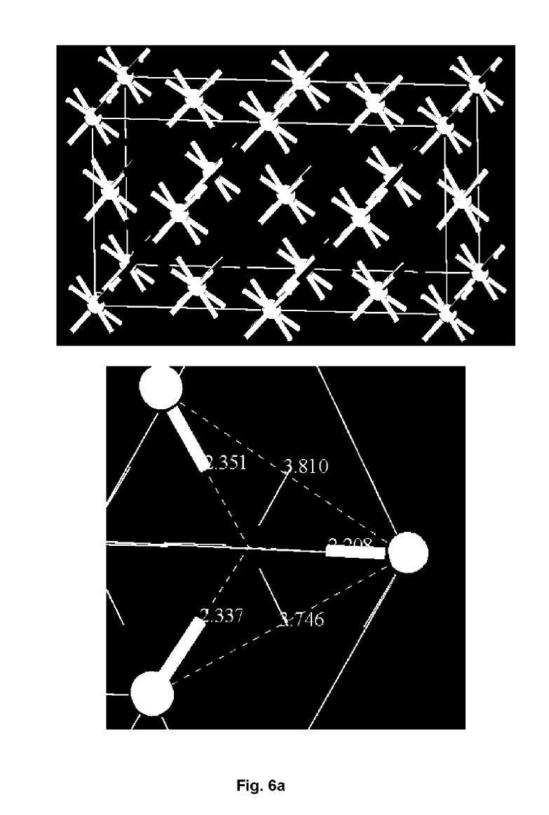

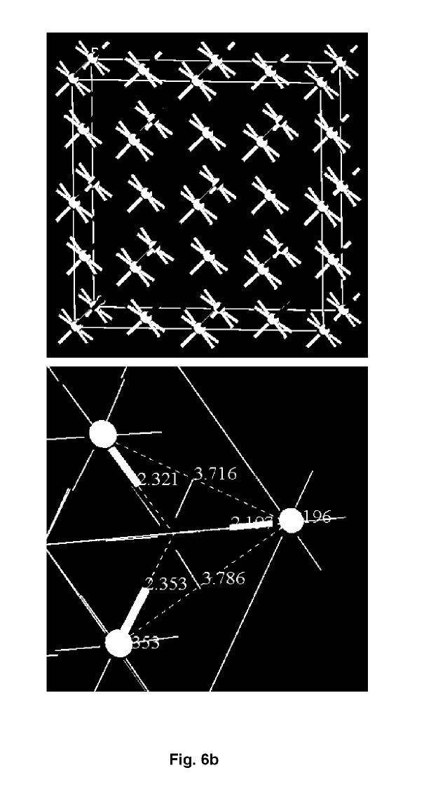

Composite FIGS. 6a and 6b shows the predicted structure of 12.5 mole percent and 25 mole percent titanium doped ceria particles, respectively. Cerium atoms are represented in the figures using the letter “C”. Titanium atoms are represented using the letter “T”. And oxygen atoms are represented using the letter “O”. The upper panels in FIGS. 6a and 6b both show the optimized unit cell, and the lower panels both show the cerium atom bonding-configuration in the vicinity of the titanium atom. The lattice parameters of the cell shown in FIG. 6a is asymmetric: 5.388 Å by 5.388 Å by 10.734 Å. The lattice parameters of the cell shown in FIG. 6b is symmetric: 5.314 Å by 5.314 Å by 5.314 Å.

For titanium-doped ceria particles, the lattice parameter of the cubic phase decreases with increasing titanium atom content up to about 30 mole percent. The increased incorporation of Ti⁴⁺ ions, which are smaller than Ce⁴⁺ ions, into the ceria lattice leads to a cell volume contraction. Pure CeO₂ has cubic unit cell containing 8 oxygen and 4 cerium atoms. The selection of titanium atoms that are multiples of the unit cell (which are also called “supercells”), different doping results are achieved. At a doping level of 25 mole percent, two cerium atoms are replaced in every cubic unit cell with two titanium atoms. At a doping level of 12.5 mole percent, one cerium atom is replaced in every cubic unit cell with a titanium atom. In the 25 mole percent dopant level, the lattice strain in the unit cell is shared symmetrically by the two titanium atoms. Hence the neighboring cerium atom bonding imbalance and the resulting lattice strain is decreased. In the 12.5 mole percent dopant level, there is asymmetry, which may explain the decrease of lattice parameter and crystal size of 20 mole percent titanium-doped ceria when compared to 10 mole percent titanium-doped ceria.

In the case of cerium-titanium composites, titanium atoms replace the cerium atoms, which results in strain and defects in the CeO₂ cubic structure. This defect energy can be calculated to increase up to 35.02 kcal/mole for a 12.5% addition of titanium atoms. Thus, such Ce—Ti composite particles are at a much higher energy level than pure CeO₂. The free energy of formation will be more negative than pure CeO₂. The particles are eager to react with SiO₂ on the surface of the wafer to release the free energy.

5. Chemical-Mechanical Polishing Performance

To study the CMP performance of these ceria particles, the chemical interactions of abrasives and oxide wafer surfaces need to be considered. This property can be discussed in terms of two points—free energy of formation and isoelectric point (IEP).

It is believed that ceria can accelerate the removal of SiO₂ by chemically reacting or bonding with the SiO₂ surface. Because CeO₂ has the lower free energy of formation (ΔG=−244.9 kcal/mole) than that of SiO₂ (ΔG=−204.75 kcal/mole), therefore, the ceria abrasives are able to bond with SiO₂ spontaneously, and reduce surface energy. This kind of bonding increases the shearing force of the abrasive particle, enhancing both the possibility that material within the indentation volume will be removed from the surface, and the possibility that the abraded material bonded to the abrasive will be removed from the vicinity of the wafer surface. Consequently, ceria yield greater removal rate than abrasives that do not exhibit the chemical tooth action, such as diamond.

In the case of TiO₂, its free energy of formation (ΔG=−211.12 and −212.6 kcal/mole for anatase and rutile, respectively) is close to that of SiO₂. As a result, the driving force of the chemical bonding between TiO₂ and SiO₂ is much smaller than that of CeO₂ with SiO₂.

On the other hand, according to DLVO theory, besides the intermolecular Van der Waals forces, which are short ranged and usually attractive forces, the long range electrostatic force between abrasives and wafer surfaces should also be considered for the chemical interaction, which is determined by the particle charge, surface charge and ionic strength. At certain slurry conductivities, the major mediator of this interaction is the slurry pH. The isoelectric point (IEP) of ceria particles is 6.5-8, depending on its synthesis technique. The IEP of TiO₂ is 5.8. And, the IEP of SiO₂ is about 2-3. In our polishing experiments, the selection of pH=4 of the slurry will result in the electrostatic attraction of ceria particle (negatively charged) with oxide film surfaces (positively charged), favoring the chemical bond or “chemical tooth” between them, and thus lead to a desired high removal rate of oxide layer.

Based on the above discussion of chemical interaction, from the view of both free energy of formation and isoelectric point, in absence of chemical additives, ceria particle will favor the oxide polishing by both chemical bonding and electrostatic attraction, while titania particle is not as ideal as ceria for oxide removal, although they have similar IEP and similar hardness (in Mho's scale, the hardnesses of CeO₂ and TiO₂ are 6 and 5.5-6.5, respectively). Thus the CeO₂ and TiO₂ crystal phase change (strained by doping) or mixing in this series is expected to have profound effect on STI CMP performance.

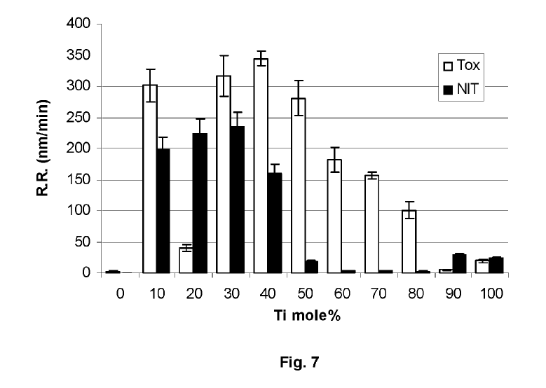

A series of CMP experiments with blanket silicon dioxide and silicon nitride wafers using slurries containing particles of Ce₁₋ₓTiₓO₂ (x=0-1), respectively, were carried out. The removal rates of oxide and nitride layers as a function of titanium mole percentage are shown in FIG. 7. The slurries contained 1.0 weight percent of the particles at a pH of 4 without any surfactant and complex agent to suppress nitride polishing. Therefore, the nitiride removal rate in this series is not near to zero, as would be the case in STI CMP processing. The testing was conducted to see what affect particle composition (crystal phase) and size had on selectively, and to also evaluate the particles' inherent “chemical activity”.

As shown in FIG. 7, pure ceria having a 6 nanometer crystal size could not give appreciable polish rate for both oxide and nitride layers, probably due to small particle entrapment in the open structures, pores and trenches of IC-1000/Suba IV pad used in these experiments. For the particles with 10 to 20 mole percent titanium, the titanium incorporation into the ceria structure increased the crystal size, particle size, and thus enhance the chemical interaction between ceria and silica surface and hence the oxide removal. With the increase of titanium doping amount to 30 to 40 mole percent, relatively little TiO₂ anatase phase appeared while ceria cubic phase is still the dominant crystal structure, and thus the removal rate of oxide layer is still high. However, with further addition of titanium atoms, the titania anatase phase became more and more dominant, indicated the stop or interruption of ceria crystal promotion by titanium doping, as well as its chemical interaction with silica surface. A higher percentage of the anatase phase is not favored for oxide removal, primarily due to the lack of a chemical tooth between TiO₂ and oxide film.

Particles formed according to the process of the invention are particularly well suited for use in CMP slurries and, more particularly, for use in the removal of oxide films in STI processing. CMP slurries can be formed using the particles as obtained via the process or by adding water, acid and/or base to adjust the abrasive concentration and pH to desired levels. Alternatively, the abrasive particles formed according to the invention can be bonded to a polishing pad.

Surfaces that can be polished using abrasive particles according to the invention include, but are not limited to TEOS silicon dioxide, spin-on glass, organosilicates, silicon nitride, silicon oxynitride, silicon, silicon carbide, computer memory hard disk substrates, silicon-containing low-k dielectrics, and silicon-containing ceramics. The abrasive particles according to the invention are particularly useful for polishing layers in semiconductor devices.

The following examples are intended only to illustrate the invention and should not be construed as imposing limitations upon the claims.

### EXAMPLE 1

In a 1000 ml plastic bottle, 41.6 grams of (NH₄)₂Ce(NO₃)₆ (ammonium cerium (IV) nitrate) was dissolved in 500 ml deionized H₂O (DI-water) and 1.2 grams CH₃COCH₂OCCH₃ (acetyl acetone) to form a solution. 2.4 grams of Ti[OCH(CH₃)₂)]₄ (titanium (IV) isopropoxide) was added to the solution followed by the addition of 36 grams of C₂H₅NH₂ (ethylamine) with stirring. A sufficient quantity of DI-water was then added to reach a final volume of 800 ml. The solution was stirred for 5 minutes and then transferred to a clean 1000 ml stainless steel vessel. The stainless steel vessel was closed and sealed, shaken for 5 minutes, and then placed into a furnace and heated at 300° C. for 6.0 hours. The stainless steel vessel was then removed from the furnace and allowed to cool to room temperature. The reaction product formed in the vessel was transferred to a clean 1000 ml plastic bottle. As shown in FIG. 1, the reaction product consisted of a dispersion of CeO₂ (cerium oxide) particles having a narrow size distribution (D₅₀=87 nm; D₉₀=101 nm; and D₁₀=68 nm). The cerium oxide particles had an average crystallite size of 210 Å.

### COMPARATIVE EXAMPLE 2

A dispersion of cerium oxide particles was formed using the same materials and procedures as set forth in Example 1, except that no Ti[OCH(CH₃)₂)]₄ (titanium (IV) isopropoxide) was used. The cerium oxide particles thus formed had a narrow size distribution (D₅₀=89 nm; D₉₀ =99 nm; and D₁₀=72 nm) similar to the cerium oxide particles formed in Example 1, but the average crystallite size was only 42 Å.

### EXAMPLE 3

A dispersion of cerium oxide particles was formed using the same materials and procedures as set forth in Example 1, except that no acetyl acetone (CH₃COCH₂OCCH₃) was used. The cerium oxide particles thus formed had a narrow size distribution (D₅₀=80 nm; D₉₀ =97 nm; and D₁₀=60 nm) similar to the cerium oxide particles formed in Example 1, but the average crystallite size was only 90 Å.

### EXAMPLE 4

Four chemical-mechanical polishing slurries were formed using cerium oxide particles. Slurry A consisted of 100 parts by weight of the cerium oxide nanoparticle dispersion formed in Example 1. Slurry B was identical to Slurry A, except that the cerium oxide nanoparticle dispersion formed in Example 2 was used instead of the cerium oxide nanoparticle solution formed in Example 1. Slurry C was identical to Slurry A, except that the cerium oxide nanoparticle dispersion formed in Example 3 was used instead of the cerium oxide nanoparticle solution formed in Example 1. Slurry D was identical to Slurry A, except that the cerium oxide nanoparticle dispersion comprised conventional calcined cerium oxide (Ferro Electronic Material Systems SRS-616A) having an average particle size of D₅₀=141 nm dispersed in water at a pH of 10.0. Identical TEOS SiO₂ (silicon dioxide) wafers were polished using Slurries A, B, C, and D, respectively. The polishing was performed using a Strasbaugh 6EC polisher, a Rodel IC1000 pad with Suba IV backing at a down pressure of 3.2 psi, and a table rotation speed of 60 rpm, and slurry flow rate of 150 ml/min. The wafer polished using Slurry A had a SiO₂ removal rate of 3500 Å/min and produced a surface having a root-mean-square average roughness of 0.8 Å. The wafer polished using Slurry B had a SiO₂ removal rate of 85 Å/min and produced a surface having a root-mean-square average roughness of 1.0 Å. The wafer polished using Slurry C had a SiO₂ removal rate of 1875 Å/min and produced a surface having a root-mean-square average roughness of 2.0 Å. And, the wafer polished using Slurry D had a SiO₂ removal rate of 4200 Å/min and produced a surface having a root-mean-square average roughness of 3.0 Å.

### EXAMPLE 5

32.34 grams of ammonium cerium (IV) nitrate was dissolved in 50 ml DI-water in a 100 ml beaker and heated to 90° C. under stirring to form an aqueous solution. Another solution containing 0.02 grams polyvinyl pyrrolidone (PVP) having a weight average molecular weight of about 29,000 admixed in 380 grams of 6M KOH in a 500 ml beaker was heated to 90° C. The aqueous cerium solution was then added to the KOH solution under constant stirring for 30 minutes. The temperature was kept at 90° C. A white precipitate was filtered off and washed with water until the pH of the filtrate was below 10. The precipitate was then dispersed in DI-water to make a total volume of 100 ml, ultrasonicated for 5 minutes and transferred into a 150 ml steel vessel and sealed. The steel vessel was then placed in a pre-heated oven at 250° C. for 6 h for hydrothermal treatment. At the end of the hydrothermal treatment, the vessel was quenched in cold water to room temperature and the slurry was removed. The so-obtained cerium oxide particles had an average particle diameter D₅₀ of 300 nm and an average crystallite size of 130 Å.

### EXAMPLE 6

The same process as described in Example 5 was repeated except that PVP was replaced with 0.02 gram of polyethylene glycol having a weight average molecular weight of about 600. The so-obtained cerium oxide particles had an average particle diameter D₅₀ of 100 nm and an average crystallite size of 150 Å.

### EXAMPLE 7

50 grams of ammonium cerium (IV) nitrate was dissolved in 50 ml DI-water in a 100 ml beaker and heated to 90° C. under stirring to form an aqueous cerium solution. Another solution comprising a mixture of 139.32 grams KOH, 234.09 grams DI-water, 21.465 grams methanol, and 10.125 grams acetone was heated to 90° C. in a 500 ml beaker. The aqueous cerium solution was then added to the KOH solution under constant stirring for 30 minutes. The temperature was kept at 90° C. A white precipitate was filtered off and washed with water until the pH of the filtrate was below 10. The precipitate was then dispersed in water to make a total volume of 100 ml, ultrasonicated for 5 minutes and transferred into a 150 ml steel vessel and sealed. The steel vessel was then placed in a pre-heated oven at 250° C. for 6 hours for hydrothermal treatment. At the end of the hydrothermal treatment, the vessel was quenched in cold water to room temperature and the slurry was removed. The so-obtained cerium oxide particles had an average particle diameter D₅₀ of 110 nm and an average crystallite size of 130 Å.

### EXAMPLE 8

22.3 grams of ammonium cerium (IV) nitrate was dissolved in 40 ml DI-water in a 100 ml beaker. Then, 2.59 grams of a mixture solution containing 1.177 grams of acetyl acetone and 1.413 grams of titanium (IV) isopropoxide was added into the ammonium cerium (IV) nitrate solution under stirring. In another beaker, 20.7 grams of concentrated ammonium hydroxide (57 wt % NH₄OH) was mixed with 20 grams of DI-water. The solution containing ammonium cerium (IV) nitrate and titanium (IV) isopropoxide was then added into the ammonium hydroxide solution under stirring, stirred for another 3 minutes, and additional DI-water added to a total final volume of 100 ml. The mixture was ultrasonicated for 5 minutes, transferred to a 150 ml steel vessel, and tightly sealed. The steel vessel was then placed in an oven preheated at 300° C. for 6 hours for hydrothermal treatment. At the end of the hydrothermal treatment, the vessel was quenched in cold water to room temperature and the slurry was removed. The so-obtained cerium oxide particles had an average particle diameter D₅₀ of 97 nm and an average crystallite size of 260 Å.

### EXAMPLE 9

71.6 grams of ammonium cerium (IV) nitrate and 35.1 grams of urea were dissolved in 700 ml DI-water in a 1000 ml beaker. Then, 7.52 grams of a mixture solution containing 3.418 grams of acetyl acetone and 4.102 grams of titanium (IV) isopropoxide was added into the ammonium cerium (IV) nitrate solution under stirring. Additional DI-water was added to mixture to a total final volume of 1286 ml. Finally, the mixture was transferred to a 2000 ml steel vessel and tightly sealed. The sealed steel vessel was then placed in an oven preheated at 300° C. for 3 hours for hydrothermal treatment. At the end of the hydrothermal treatment, the vessel was quenched in cold water to room temperature and the slurry was removed. The so-obtained cerium oxide particles had an average diameter D₅₀ of 860 nm and an average crystallite size of 2480 Å.

### EXAMPLE 10

The process as described in Example 9 was repeated except that ammonium cerium (IV) nitrate was replaced with 56.4 grams of Ce(NO₃)₃ (cerium (III) nitrate). The so-obtained cerium oxide particles had an average diameter D₅₀ of 910 nm and an average crystallite size of 2220 Å.

### EXAMPLE 11

122 grams of (NH₄)₂Ce(NO₃)₆ (ammonium cerium (IV) nitrate) was dissolved in 400 ml deionized H₂O (DI-water) in a plastic bottle marked Sample 11-A. 102 grams of 28% (by weight) NH3 water was then added, followed by an additional amount of H₂O to a reach final volume of 700 ml.

122 grams of (NH₄)₂Ce(NO₃)₆ (ammonium cerium (IV) nitrate) was dissolved in 400 ml deionized H₂O (DI-water) in a plastic bottle marked Sample 11-B. 4.2 grams of CH₃COCH₂OCCH₃ (acetyl acetone) and then 5.1 grams of Ti[OCH(CH₃)₂)]₄ (titanium (IV) isopropoxide) were added. Next, 106 grams of 28% (by weight) NH3 water was then added, followed by an additional amount of H₂O to reach a final volume of 700 ml.

122 grams of (NH₄)₂Ce(NO₃)₆ (ammonium cerium (IV) nitrate) was dissolved in 400 ml deionized H₂O (DI-water) in a plastic bottle marked Sample 11-C. 7.45 grams of CH₃COCH₂OCCH₃ (acetyl acetone) and then 8.9 grams of Ti[OCH(CH₃)₂)]₄ (titanium (IV) isopropoxide) were added. Next, 106 grams of 28% (by weight) NH3 water was then added, followed by an additional amount of H₂O to reach a final volume of 700 ml.

Each solution was stirred for 5 minutes and then transferred to a clean 1000 ml stainless steel vessel. Each stainless steel vessel was closed and sealed, shaken for 5 minutes, and then placed into a furnace and heated at 300° C. for 6.0 hours. Each stainless steel vessel was then removed from the furnace and allowed to cool to room temperature. The reaction product formed in each vessel was transferred to a clean 1000 ml plastic bottle. The particles were filtered from the solution, washed and dried to yield a dry powder.

The particles from Samples 11-A, 11-B and 11-C were separately used to form slurries by dispersing 1 gram of dry powder in 1000 ml of water. An amount of nitric acid (HNO₃) was added to adjust the pH of each of the slurries to 4.0. The slurries were then used to separately polish 6-inch blanket thermal silicon oxide wafers. The polishing was performed on a Westech 372 polisher using a, IC-10001 Suba-IV pad. Down pressure was 3.5 psi with no back pressure. Carrier/pad rotation was 93 and 87 rpm. The feeding rate of the slurry was 150 ml/min. The properties of the particles and their effectiveness in removing oxide films is detailed in Table 2 below:

TABLE 2

| Sample | Mole % Ti | D₅₀ | Crystallite Size | Removal Rate |
|---|---|---|---|---|
| 11-A | 0.0 | 78 nm | 6 nm | 2 nm/min |
| 11-B | 5.95 | 79 nm | 15 nm | 166 nm/min |
| 11-C | 10.0 | 473 nm | 18 nm | 301 nm/min |

The data in Table 2 shows that for the range of 0 to 10 mole percent, as the concentration of titanium in the particle increases, the crystallite and secondary particle size increases, thereby increasing the oxide removal rate.

### EXAMPLE 12

Eleven samples (Samples 12-A through 12-K) of abrasive particles were formed with varying concentrations of titanium and cerium atoms by hydrothermal synthesis using the same procedures as used in Example 11 (the amounts of ammonium cerium (IV) nitrate and titanium (IV) isopropoxide were adjusted, as necessary, to obtain particles having the desired concentrations of titanium and cerium atoms).

The resulting particles were then used to form slurries for polishing 6-inch blanket thermal silicon oxide wafers. Polishing conditions were the same as used in Example 11. The properties of the particles and their effectiveness in removing oxide and nitride films is detailed in Table 3 below:

TABLE 3

| | | | | Oxide | | |
|---|---|---|---|---|---|---|
| | | | | Removal | Surface | Oxide |
| | Mole | D₅₀ | Crystallite | Rate | Roughness | to Nitride |
| Sample | % Ti | (nm) | Size (nm) | (nm/min) | (Rq nm) | Selectivity |
| 12-A | 0 | 78 | 6 | 1.5 | 1-1.5 | 2.90 |
| 12-B | 10 | 473 | 15 | 301 | 1-1.2 | 1.52 |
| 12-C | 20 | 249 | 10 | 40 | 1.1-1.5 | 0.18 |
| 12-D | 30 | 561 | 27 | 316 | 0.9-1.5 | 1.35 |
| 12-E | 40 | 714 | 35 | 344 | 1.7-1.9 | 2.16 |
| 12-F | 50 | 918 | 62 | 280 | 0.8-2.0 | 15.31 |
| 12-G | 60 | 799 | 85 | 182 | 2.1-3 | 55.26 |
| 12-H | 70 | 852 | 50 | 256 | 1.1-1.4 | 51.98 |
| 12-I | 80 | 67 | 48 | 101 | 1.4-1.9 | 37.35 |
| 12-J | 90 | 67 | 27 | 4.6 | 1.2-1.5 | 0.16 |
| 12-K | 100 | 69 | 7 | 20 | 1.1-1.2 | 0.85 |

As previously noted above, when the mole percentage of titanium atoms in the crystals is within the range of 0 to about 30, the only or major crystal phase is the ceria cubic phase. Titanium atom doping results in an increase in crystal size, which results in an enhancement of the CeO₂ contact with oxide or nitride and a concomitant increase of both oxide and nitride removal. Hence, no significant differences are noted in selectivity. However, when the titanium doping mole percentage is greater than 40% but less than 80%, the appearance of the titania anatase phase, and its increasing percentage in the slurry, leads to a decrease in nitride removal. Oxide removal is still significant, which might be due to the chemical bonding of SiO₂ surface with the presented ceria cubic crystal surface. As a result, the selectivity in this range is high. When the titanium mole percentage in the abrasive particles is larger than 90%, both the oxide and nitride removal are not pronounced enough, because titania anatase phase is not favor for oxide and nitride polishing due to its lack of chemical bonding with oxide surface. This may also result from the entrapment of small particles in the groove of pad like the case of pure ceria particles.

The corresponding root-mean-square surface roughnesses (Rq) of the oxide wafers after polishing is listed in Table 3. The polishing with pure ceria particle results in a smooth surface, because of their small particle size. And the smooth surface happened for 10-30% Ti-doped ceria indicates the reasonable monodispersed particle size in this range for STI CMP. The predominance of titania anatase phase in 40-80% Ti-doped or mixed ceria slurries makes the polishing be mostly controlled by mechanical abrasion without enough chemical bonding with oxide surface. The rough surfaces from the slurries in this range are probably due to the indentation of some big aggregate, which, even in very low concentration, will lead to the large local pressure applied on the big particle against the surface, and hence the pitting or scratches on the surface. The wafer surfaces polished by 90% or 100% TiO₂, lead to a smooth surface, probably also because of their small particle size like pure ceria particles.

Based on the foregoing, the 10 mole percent titanium-doped ceria particles appear to be the most promising candidates for preparing a CMP slurry that provides a high oxide polish rate (301 nm/min) with good surface finish (Rq=1-1.2 nm), as well as the reasonable oxide to nitride selectivity even without any chemical additives at a pH of 4. Even better results could be expected when the slurry includes a surfactant and/or a complexing agent to suppress nitride removal.

### EXAMPLE 13

Three samples of 10 mole percent titanium-doped ceria abrasive particles (Samples 13-A, 13-B and 13-C) were formed using the hydrothermal treatment procedures described in Example 11. In Sample 13-A, 4.3 times as many moles of potassium hydroxide per mole of metal cations (titanium and cerium) were used during the synthesis to produce abrasive particles having an octahedral shape. In Sample 13-B, 6 times as many moles of ammonium hydroxide per mole of metal cations (titanium and cerium) were used during the synthesis to produce abrasive particles having a truncated octrahedron shape. And, in Sample 13-C, 4 times as many moles of urea per mole of metal cations (titanium and cerium) were used during the synthesis to produce abrasive particles having a polyhedron shape.

The particles were separately used at a 1.0 weight percent loading to prepare CMP slurries. NaOH was added to raise the pH of each of the slurries to 9. The CMP slurries were used to polish thermal oxide wafers. The results are reported in Table 4 below:

TABLE 4

| | | | Removal | |
|---|---|---|---|---|
| Sample | Base | D₅₀ | Rate | Shape |
| 13-A | KOH (4.2×) | 803 | 4005 nm/min | Octahedral |
| 13-B | NH4OH (6×) | 727 | 3112 nm/min | Trucated Octahedron |
| 13-C | CO(NH₂)₂ (4×) | 3460 | 8054 nm/min | Polyhedron |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method of removing at least a portion of a film disposed on a substrate by chemical-mechanical polishing, the method comprising:
preparing a slurry composition comprising doped cerium oxide abrasive particles having crystallites with crystal lattice structures that include cerium atoms and atoms of one or more metals other than cerium, wherein the abrasive particles in the slurry are formed by a hydrothermal process comprising the steps of:
(i) providing an aqueous reaction mixture comprising:
(a) one or more compounds that provide a source of cerium ions, and
(b) one or more compounds that provide a source of doping ions selected from the group consisting of Be, B, Mg, Al, Si, Ca, Sc, Ti, V, Cr, Mn, Fe, Co, Ni, Zn, Ga, Ge, As, Sr, Y, Zr, Nb, Mo, Tc, Ru, Rh, Pd, Ag, Cd, In, Sn, Sb, Te, Ba, La, Pr, Nd, Pm, Sm, Eu, Gd, Tb, Dy, Hp, Er, Tm, Yb, Lu, Hf, Ta, W, Re, Os, Ir, Pt, Au, Hg, TI, Pb, Bi, and combinations thereof,
(ii) contacting the aqueous reaction mixture with a base to raise the pH to above about 1.5, and,
(iii) subjecting the aqueous reaction mixture to hydrothermal treatment at a temperature of from about 70° C. to about 500° C. to produce the abrasive particles,
wherein the abrasive particles in the slurry have a primary particle size, a secondary particle size, an elemental composition, and a morphology that is sufficient to produce a desired film removal rate using a predetermined set of chemical-mechanical polishing parameters,
wherein the primary particle size of the abrasive particles is inversely proportional to doping ion concentration, inversely proportional to the doping ion valence, proportional to the base concentration, proportional to reaction temperature and proportional to reaction time,
wherein the secondary particle size of the abrasive particles is proportional to doping ion concentration, proportional to doping ion valence, proportional to base concentration, inversely proportional to reaction temperature and inversely proportional to reaction time, and
wherein the elemental composition of the abrasive particles is determined by the initial concentrations of cerium ions and doping ions in the reaction mixture; and
polishing the film using the slurry composition to remove at least a portion of the film.

2. The method of claim 1 wherein the particle morphology is determined by the use of a basic hydroxide anion-contributing reagent such that the particle volume is proportional to the concentration of hydroxide anion contributed by said reagent.

3. In a chemical-mechanical polishing operation for removing at least a portion of a film disposed on a substrate using a polishing apparatus and a slurry composition comprising abrasive particles, the improvement comprising selecting a primary and a secondary size of the abrasive particles, an elemental composition of the abrasive particles, a morphology of the abrasive particles, and a pH of the slurry composition to control the rate at which the film is removed.

4. A method of producing a doped cerium oxide abrasive via a hydrothermal process for use in formulating a slurry composition that removes a film disposed on a substrate at a different removal rate than a slurry composition containing the same constituents, except for the doped cerium oxide abrasive, using the same chemical-mechanical polishing parameters, the method comprising:
varying a primary particle size, a secondary particle size and/or a lattice strain of the doped cerium oxide abrasive by altering:
(i) valence of a doping ion used to form the doped cerium oxide abrasive;
(ii) initial concentration of the doping ion in a reaction mixture to make the doped cerium oxide abrasive;
(iii) reaction temperature; and/or
(iv) reaction time.

5. In the fabrication of an electronic device wherein a film is removed by chemical-mechanical polishing using a slurry comprising abrasive particles, the improvement comprising adjusting the rate of film removal without changing polishing parameters including rotation speed and pressure of the polishing apparatus and the flow rate of the slurry by selectively altering the chemical composition, lattice strain and/or morphology of the abrasive particles.

6. A method of removing a film in a chemical-mechanical polishing operation comprising:
providing an apparatus for chemical-mechanical polishing a substrate using predetermined polishing parameters;
using a first slurry composition that removes the film at a first removal rate;
providing a second slurry composition for use in place of the first slurry composition to remove the film at a second removal rate, and
blending the first and second slurries in sufficient quantities and ratios to provide any removal rate between the first and second removal rates.

7. In an electronic device fabrication process wherein a slurry composition is used to remove a film on a substrate by chemical-mechanical polishing, the improvement comprising selectively formulating the slurry composition using doped cerium oxide abrasives formed via a hydrothermal synthesis process to alter the film removal rate without changing any other chemical-mechanical polishing parameters, the doped cerium oxide abrasives having crystallites containing cerium atoms and one or more doping atoms of elements selected from the group consisting of Be, B, Mg, Al, Si, Ca, Sc, Ti, V, Cr, Mn, Fe, Co, Ni, Zn, Ga, Ge, As, Sr, Y, Zr, Nb, Mo, Tc, Ru, Rh, Pd, Ag, Cd, In, Sn, Sb, Te, Ba, La, Pr, Nd, Pm, Sm, Eu, Gd, Tb, Dy, Hp, Er, Tm, Yb, Lu, Hf, Ta, W, Re, Os, Ir, Pt, Au, Hg, Tl, Pb, and Bi, the doping ions producing a lattice strain sufficient to produce the desired film removal rate.
